(19) United States
(12) Patent Application Publication
(10) Pub. No.: US 2021/0158554 A1
(43) Pub. Date: May 27, 2021

(54) ARTIFICIAL INTELLIGENCE FOR GENERATING DEPTH MAP

(71) Applicant: Social Nation, Inc., Millbrae, CA (US)

(72) Inventors: Chulayuth Asawaroengchai, Bangkok (TH); Sittiphol Phanvilai, Bangkok (TH); Pairote Leelaphattarakij, Bangkok (TH); Vibhavee Trairattanapa, Bangkok (TH); Sarin Achawaranont, Bangkok (TH); Phoomparin Mano, Bangkok (TH); Ekasit Awatchanakanwong, Bangkok (TH); Nawaporn Upariboon, Bangkok (TH); Jatupon Sukkasem, Bangkok (TH); Prachaya Phaisanwiphatpong, Millbrae, CA (US); Michael Rucker, Redwood City, CA (US)

(21) Appl. No.: 16/698,731

(22) Filed: Nov. 27, 2019

(51) Int. Cl. G06T 7/55; G06K 9/00; G06T 7/70; G06T 7/194; G06T 7/11; G06T 17/00

(52) U.S. Cl. CPC G06T 7/55; G06K 9/00362; G06T 7/70; G06T 7/194; G06T 7/11; G06T 2207/20081; G06K 9/00228; G06T 2207/30201; G06T 2207/20132; G06T 2207/20084; G06T 17/00

(57) ABSTRACT

Systems and methods for generating depth maps. The systems and methods may provide for receiving a plurality of two-dimensional (2D) photo images, inputting a first 2D photo image into a person detector to determine whether a person is present in the first 2D photo image when the first 2D photo image contains a person, detecting the position of a face of the person and creating a cropped image of the face of the person, inputting the cropped image of the face of the person to a face depth map generator to create a face depth map, segmenting the first 2D photo image into person and background segments, each segment containing one or more pixels, assigning higher depth values to the pixels in the person segment than the pixels in the background segment to create a scene depth map, and combining the face depth map and scene depth map to create a combined depth map of the first 2D photo image.

### BACKGROUND

The following relates generally to depth map generation, and more specifically to the automatically generating depth map images from two dimensional (2D) images.

Both two dimensional (2D) and 3D images are used in a wide variety of applications. In some cases, it is desirable to create a 3D image from a 2D image. For example, advertisers often use 2D images to create online advertising banners. This is because 2D technology is provided out-of-the-box by web browsers and does not require a special system to design and implement the ads. However, ad banners created using 2D images may not be as effective as 3D images at drawing attention. Furthermore, creating 3D images using existing techniques may be costly and time consuming. Therefore, it would be desirable for advertisers and other producers and consumers of images to efficiently generate 3D images.

### SUMMARY

A computer-implemented method, apparatus, and non-transitory computer readable medium for generating a depth map are described. The computer-implemented method, apparatus, and non-transitory computer readable medium may provide for detecting whether a two-dimensional (2D) photo image contains a person. If the 2D photo image contains a person, then the person's face may be cropped from the image and a face depth map generator may be applied to generate a depth map of the face. Segmentation may be applied to the 2D photo image to segment the image into the person and background. A scene depth map may be created based on the person and background. The depth map of the face and the scene depth map may be combined to create a combined depth map. Meanwhile, if the 2D photo image does not contain a person, then a scene depth map generator may be applied to the 2D photo image to create a depth map of the 2D photo image.

One exemplary method herein comprises receiving a plurality of two-dimensional (2D) photo images, inputting a first 2D photo image into a person detector to determine whether a person is present in the first 2D photo image when the first 2D photo image contains a person, detecting the position of a face of the person and creating a cropped image of the face of the person, inputting the cropped image of the face of the person to a face depth map generator to create a face depth map, segmenting the first 2D photo image into person and background segments, each segment containing one or more pixels, assigning higher depth values to the pixels in the person segment than the pixels in the background segment to create a scene depth map, and combining the face depth map and scene depth map to create a combined depth map of the first 2D photo image.

Further, the computer-implemented method, apparatus, and non-transitory computer readable medium may provide for inputting a second 2D photo image into the person detector to determine whether a person is present in the second 2D photo image. When the second 2D photo image does not contain a person, inputting the second 2D photo image to a scene depth map generator to create a depth map of the second 2D photo image.

### BRIEF DESCRIPTION OF THE DRAWINGS

The present disclosure will become better understood from the detailed description and the drawings, wherein:

FIG. 1 shows an example of an image generation system in accordance with aspects of the present disclosure.

FIG. 2 shows an example of an image generation module in accordance with aspects of the present disclosure.

FIG. 3 shows an example of an overview of a process for generating a depth maps from 2D input images in accordance with aspects of the present disclosure.

FIGS. 4 and 5A-B show examples of a process for generating a depth map in accordance with aspects of the present disclosure.

FIG. 6 shows an example of a process for semantic segmentation in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

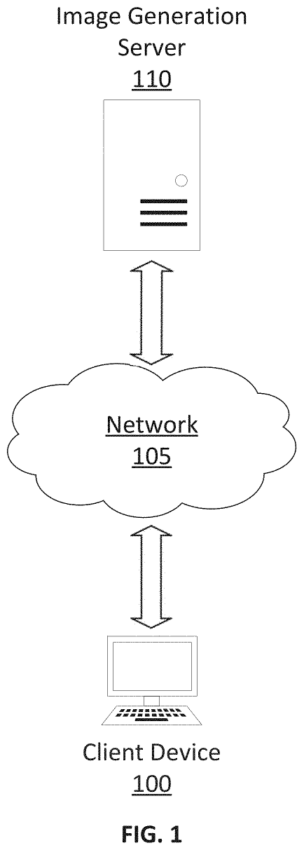

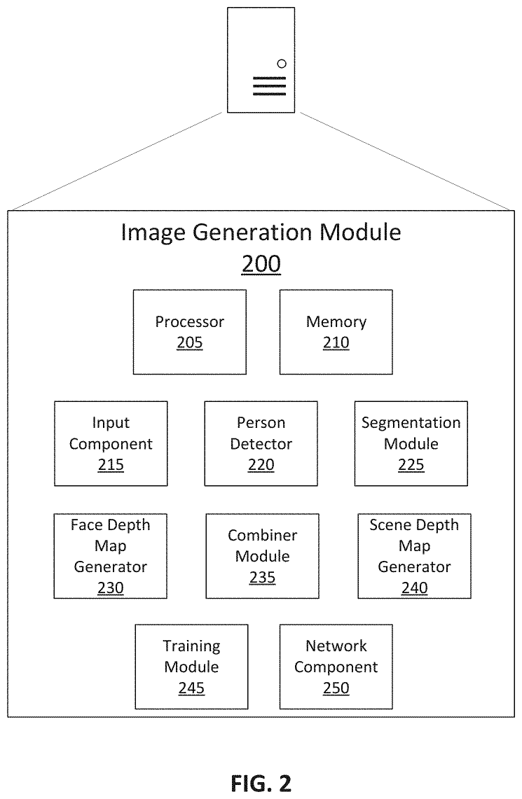

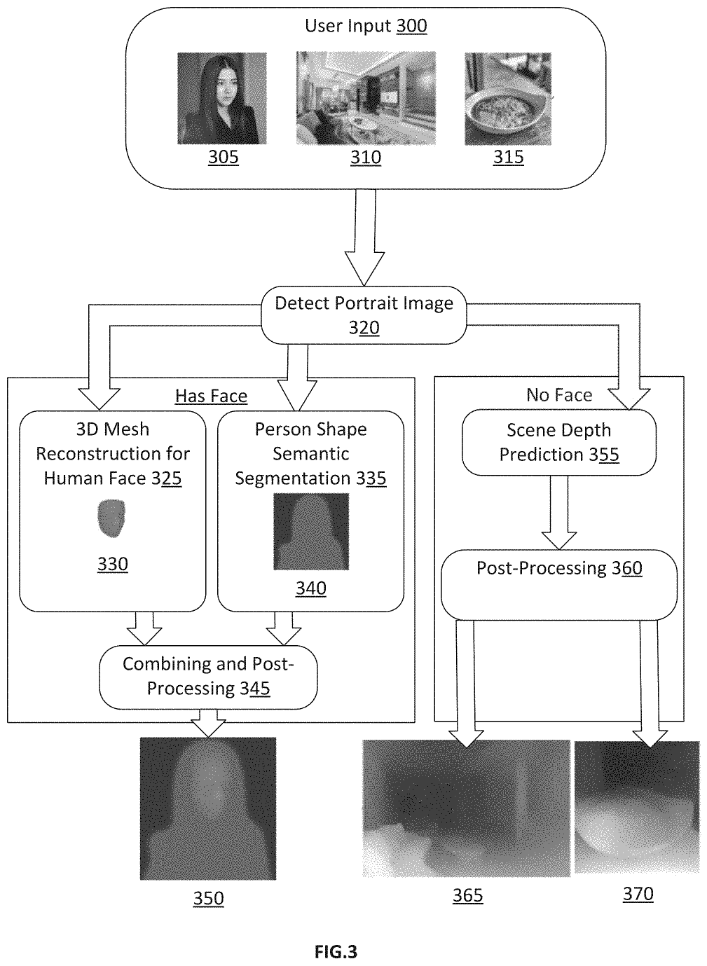

FIG. 1 shows an example of an image generation system in accordance with aspects of the present disclosure. The example shown includes client device 100, network 105, and image generation server 110. In one example, the client device 100 is used (e.g., by a person creating an advertising banner) to upload image data (e.g., 2D photo image) to the image generation server 110 via the network 105. Image generation server 110 may be an example of, or include aspects of, the corresponding element or elements described with reference to FIG. 2.

In one embodiment, the image generation system takes one or more 2D photo images as input (e.g., via the client device 100). After uploading the one or more images, the image generation system analyzes and processes the input image to generate depth maps of the respective input images. A depth map may be in the form of a grayscale photo where the brightness of each pixel represents the depth value of the original image at the same position. The input images and their respective depth maps may then be used in a 3D mesh generation process to create 3D model representations of the input images. These models may be used in the creation of 3D advertisements (e.g., banner ads) or other 3D media.

Embodiments of the image generation system provide for ease-of-creation—that is, a process to create 3D experience that may be performed from a wide variety of 2D photo editing software applications. The system may also provide for improved scale-of-distribution—that is, distributing the 3D experience may be scalable and feasible within the current digital advertisement ecosystem. Thus, for example, the system may utilize common web-based protocols.

Thus, the present disclosure provides for an image generation system that takes a 2D image as input, automatically generates a depth map for the input image, and provides an output that may be distributed via common web protocols and languages including hypertext markup language (HTML). In one embodiment, an end-to-end web application is provided that enables the creation and distribution in a single interface.

In some embodiments, the system may process a wider range of input scenes than traditional methods. The system contains multiple depth map generators, many of which are optimized for specific types/classes of objects present in the input image. The determination of the particular depth map generator is performed automatically, without human intervention. The determination may be made for the entire image or parts thereof. For example, the input image may contain many different objects (e.g., human face, human body, background, table, wall, trees, crowds), and the system may automatically analyze the image to recognize objects and types of objects and determine which depth map generators to use for each of the recognized object based on the classification. The resulting depth maps may then be merged to construct a final depth map of the input image.

The system may also select a single depth map generator for the entire input image. Upon analysis, the system may determine the depth map generator that is best suited for the image as a whole. This would result in a reduction in the processing time required for each input image.

Thus, the image generation system makes the process of 3D photo creation fully automated, without the need for human intervention. Automation of the image 3D photo creation allows for a reduction of time, both user and computation, cost-savings, and is less error-prone than previous methods.

Alternatively, a user may be allowed to modify the choice of depth map generator or customize the selected depth map generator to fine tune the results for specific input images. A user may also create a new depth map generator by a supervised or unsupervised learning process.

In some embodiments, the system may be integrated with an existing ad building and editing software. For example, the image generation system workflow can be integrated as a plugin or custom template implementation. In some embodiments, an HTML output associated JavaScript renderer operates as a generic web component that can be used outside an ad application (for example, embedded as a 3D photo on a website). Embodiments of the disclosure also provide for a 2D overlay feature. For example, additional 2D experiences can be overlaid on top of 3D ads as part of the workflow described herein.

Thus, the present disclosure provides efficient means of creating 3D images, including 3D advertisement experiences. 3D ad experiences grab audiences' attention effectively, which makes the ad messages and visual graphics stand out. 3D ads may also be clearly distinguishable from surrounding content, which results in more effective advertising.

In some embodiments, 3D Photos are created from existing 2D image editing software (photoshop, etc.). When the inputs are implemented in the described system, 3D ads may be created without 3D models (i.e., from a 3D modeling software), which may increase the ease of 3D ad creation.

In some embodiments, some or all of the processes performed by the image generation server 110 may instead be performed on the client device 100.

FIG. 1 shows an example of an image generation module 100 in accordance with aspects of the present disclosure. Image generation module 100 may be an example of, or include aspects of, the corresponding element or elements described with reference to FIG. Error! Reference source not found. In an embodiment, image generation module 200 comprises image generation server 110. In other embodiments, image generation module 200 is a component or system on client device 100 or peripherals or third-party devices. Image generation module 200 may comprise hardware or software or both.

Image generation module 100 may include processor 105, memory 110, input component 115, person detector 120, segmentation module 125, face depth map generator 130, combiner module 135, scene depth map generator 140, training module 245, and network component 150.

A processor 205 may include an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 205 may be configured to operate a memory array using a memory controller. In other cases, a memory controller may be integrated into processor 205. The processor 205 may be configured to execute computer-readable instructions stored in a memory to perform various functions related to generating 3D images.

Memory 210 may include random access memory (RAM), read-only memory (ROM), or a hard disk. The memory 210 may be solid state or a hard disk drive, and may store computer-readable, computer-executable software including instructions that, when executed, cause a processor to perform various functions described herein. In some cases, the memory 210 may contain, among other things, a BIOS which may control basic hardware or software operation such as the interaction with peripheral components or devices. In some cases, a memory controller may operate memory cells as described herein.

Input component 115 may receive a two-dimensional (2D) photo image from the client device 100. The 2D photo image may be received as an uploaded file from a user. Input component 115 may also receive a user input to initiate generation of the 3D image.

Person detector 220 may determine the presence of a person in the 2D photo image received by the input component 215. The analysis of the input image by the person detector 220 may be performed by a machine learning model, such as one or more artificial neural networks. The machine learning model may be trained specifically for person detection, face detection, body detection, or for the detection of part of a person.

Upon detection of a human face in the input image, person detector 220 may extract position information of the face. Person detector 220 may further crop the detected face region from the input image for use by the face depth map generator 230.

Segmentation module 225 may receive information from person detector 220, such as, the input images, position information of the face region, the cropped face image, and the input image after the cropping process. The segmentation module 225 may use a separate machine learning model to segment the human body from the background. The separate machine learning model may be an artificial neural network, convolution neural network, or other machine learning model. The segmented pixels may then filled with a higher depth level than pixels of the background area to generate a depth map of the human body.

Face depth map generator 230 may receive a cropped face image and position information from the person detector 220. A machine learning model, such as an artificial neural network, may then be used to reconstruct volumetric information of the human face. The volumetric reconstruction may be a 3D mesh reconstruction process. The face depth map generator 230, may then convert the reconstructed volumetric information into a grayscale depth map of a human face.

Combiner module 235 may receive the depth map of the human body from segmentation module 225 and the depth map of the human face from face depth map generator 230. The depth map of the human body and the depth map of the human face may then be blended together to generate a final depth map.

Scene depth map generator 240 may receive the input image upon person detector 220 failing to determine the presence of a person in said image. A depth map of the scene may then be constructed through analysis of the input image by a machine learning model, such as an artificial neural network. The machine learning model may be trained on and optimized for depth estimation of landscapes and different types of recognized objects.

Training module 245 may include a depth prediction model and one or more training sets. The depth prediction model may comprise one or more systems or algorithms that take a 2D image and output a depth map. In some cases, the one or more training sets include 2D images and corresponding depth maps which can be used to train the depth prediction model. Thus, depth prediction model may generate a depth map from a 2D image, where the depth prediction model is trained on a dataset of images and corresponding depth maps.

In some cases, the depth prediction model may comprise a neural network (NN). A NN may be a hardware or a software component that includes a number of connected nodes (a.k.a., artificial neurons), which may be seen as loosely corresponding to the neurons in a human brain. Each connection, or edge, may transmit a signal from one node to another (like the physical synapses in a brain). When a node receives a signal, it can process the signal and then transmit the processed signal to other connected nodes. In some cases, the signals between nodes comprise real numbers, and the output of each node may be computed by a function of the sum of its inputs. Each node and edge may be associated with one or more node weights that determine how the signal is processed and transmitted.

During the training process, these weights may be adjusted to improve the accuracy of the result (i.e., by minimizing a loss function which corresponds in some way to the difference between the current result and the target result). The weight of an edge may increase or decrease the strength of the signal transmitted between nodes. In some cases, nodes may have a threshold below which a signal is not transmitted at all. The nodes may also be aggregated into layers. Different layers may perform different transformations on their inputs. The initial layer may be known as the input layer and the last layer may be known as the output layer. In some cases, signals may traverse certain layers multiple times. In one example, the training set may include a large number of images as input and a corresponding set of depth maps as the target output.

Network component 250 may transmit and receive data and receive data from other computing systems via a network. In some embodiments, the network component 250 may enable transmitting and receiving data from the Internet. Data received by the network component 250 may be used by the other modules. The modules may transmit data through the network component 250.

FIG. 3 shows an example of the overall process of the image generation system in accordance with aspects of the present disclosure. In this example user input 300 comprises three 2D photo images, image 305, image 310, and image 315. The images are received from a client device 100 through the input component 215 of the image generation module 200.

In detect portrait image step 320, the image generation system receives image 305, 310, and 315 from user input 300. The images 305, 310, and 315 are then analyzed by person detector 220, which may comprise an artificial neural network or other machine learning model, to determine whether or not a person is present in the image. The artificial neural network or machine learning model is specifically trained for person detection. The person detector 320 may determine that image 305 contains a person and detect a face region in said image. The face region position information is extracted, and the face region is cropped from the remaining portions of the image. The face cropped face region and extracted face region position information are then passed to 3D mesh reconstruction for human face 320. Image 305 is then passed to person shape semantic segmentation step 335.

In 3D mesh reconstruction for human face step 325, upon receiving the cropped face region and extracted face region position information, the face depth map generator 320 reconstructs volumetric information of the human face. Face depth map generator 230, which may comprise an artificial neural network or other machine learning method, is trained to estimate 3D position of pixels relating to 2d face regions. Face depth map generator 230 analyzes the received information and maps the extracted face region to a 3D mesh model. The 3D mesh reconstruction is then converted into a grayscale depth map of the human face 330.

In person shape semantic segmentation step 335, upon receiving image 305, the segmentation module 225 performs semantic segmentation to separate the part of the human body from the background of the image. Segmentation module 225, which may comprise an artificial neural network or other machine learning model, is used to perform the segmenting of image 305 into a background segment and a human body segment. The pixels within the human body segment of image 305 are then filled with a higher depth level than pixels of the background segment to generate depth map 340.

Combining and post-processing step 345 may be performed by combiner module 235. The combiner module 235 may combine both the depth map of the human face 330 with the depth map generated by semantic segmentation 340. Depth maps 330 and 340 are blended together to generate a final depth map 350.

Image 310 and 315 are determined to not contain a person in detect portrait image step 320, which may be performed by person detector 220. In depth prediction step 355, image 310 and 315 are passed to be analyzed by scene depth map generator 240, which may comprise an artificial neural network or other machine learning model. The machine learning model may be an artificial neural network or convolution neural network that has been trained and optimized with regard to landscape and any number of recognized object types. The predicted depth maps for images 310 and 315 are then received by post-processing 360. Post-processing 360 may then detect artifacts, smooth problem regions, anti-alias edges, or any other process to improve the quality and accuracy of the final depth map. Upon completion of post-processing 360, the final depth maps 365, 370 for image 310 and 315 are generated.

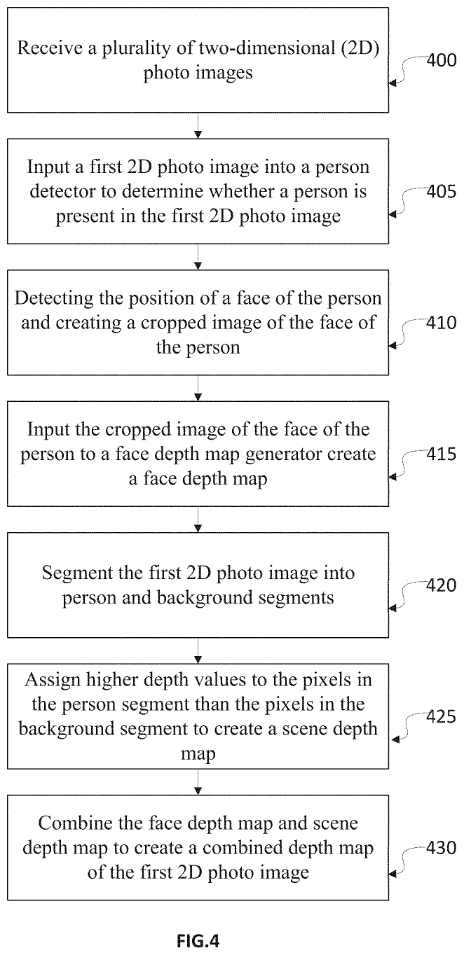

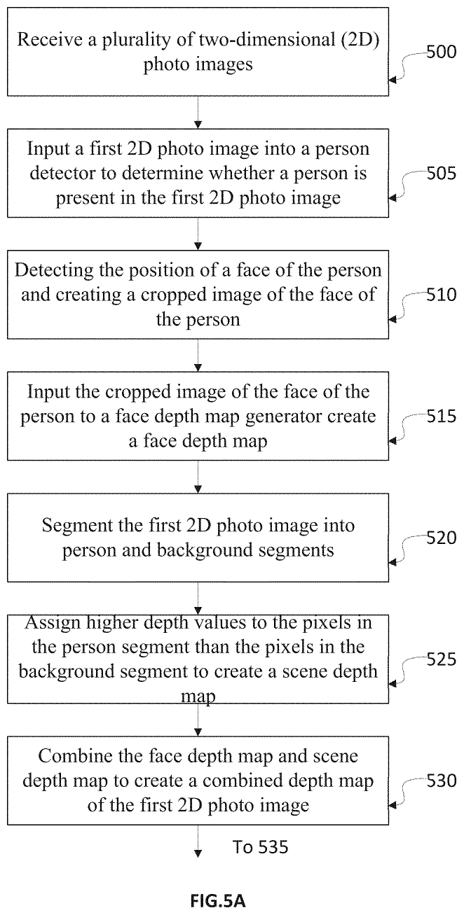

FIG. 4 shows an example of the overall process of the depth map generation for an image that contains a person in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 400, the system receives a plurality of 2D photo images. In some cases, the operations of this step may refer to, or be performed by, an input component as described with reference to FIG. 1. For example, the 2D photo image may be uploaded from a client device 100 through the input component 215.

At step 405, the system inputs a first 2D image into a person detector to determine whether a person is present in the first 2D photo image. In some cases, the operation of this step may refer to, or be performed by, a person detector component as described with reference to FIG. 2. For example, the first 2D image may be analyzed by an artificial neural network, or other machine learning model, to determine the presence of a person or not.

At step 410, the system detects the position of a face of the person and creates a cropped image of the face of the person. In some cases, the operations of this step may refer to, or be performed by, a person detector component as described with reference to FIG. 1. For example, a neural network or other machine learning model may be used to classify and extract position information of a face region of the person in the first 2D image. This information may then be used to crop the pixels which make up the face region,

At step 415, the system inputs the cropped image of the face of the person to a face depth map generator to create a face depth map. In some cases, the operations of this step may refer to, or be performed by, a face depth map generator as described with reference to FIG. 1. For example, the cropped image of the persons face along with the extracted position information of the face region may be used to reconstruct volumetric information of the face. This information may be converted or mapped to a 3D mesh model of a human face. An artificial neural network or other machine learning model may be used to estimate depth of pixels in the cropped image, allowing for the construction of a 3D mesh that is mapped to respective points on the cropped image. This 3D mesh is used to convert the volumetric information into a grayscale depth map of a human face.

At step 420, the system segments the first 2D photo image into person and background segments. In some cases, the operations of this step may refer to, or be performed by, a segmentation module as described with reference to FIG. 1. For example, the first 2D photo image may be analyzed by an artificial neural network or other machine learning model to classify and segment different portions of the image. The artificial neural network is trained and optimized for the detection of people and backgrounds. An edge detection process (e.g., Hough transform) may also be used to aid in the segmentation of foreground objects, like a person, from the background.

At step 425, the system assigns higher depth values to the pixels in the person segment than the pixels in the background segment to create a scene depth map. In some cases, the operations of this step may refer to, or be performed by, a segmentation module as described with reference to FIG. 1.

At step 430, the system combines the face depth map and scene depth map to create a combined depth map of the first 2D photo image. In some cases, the operations of this step may refer to, or be performed by, a combiner module as described with reference to FIG. 1. For example, the face depth map and scene depth map may be blended together and post-processed to generate the final depth map.

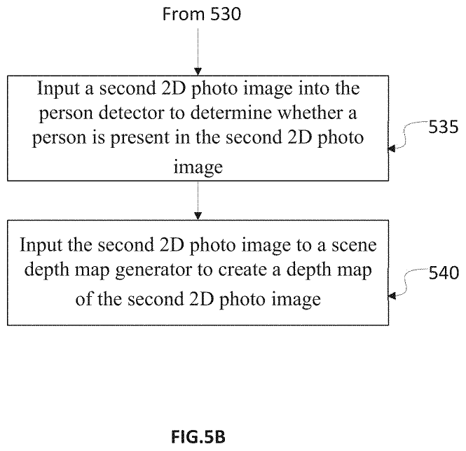

FIGS. 5A-B show an example of the overall process of the depth map generation for one or more images in accordance with aspects of the present disclosure. A first 2D photo image contains a person, and a second 2D photo image does not contain a person. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, the system receives a plurality of 2D photo images. In some cases, the operations of this step may refer to, or be performed by, an input component as described with reference to FIG. 1. For example, the 2D photo image may be uploaded from a client device 100 through the input component 215.

At step 505, the system inputs a first 2D image into a person detector to determine whether a person is present in the first 2D photo image. In some cases, the operation of this step may refer to, or be performed by, a person detector component as described with reference to FIG. 2. For example, the first 2D image may be analyzed by an artificial neural network, or other machine learning model, to determine the presence of a person or not.

At step 510, the system detects the position of a face of the person and creates a cropped image of the face of the person. In some cases, the operations of this step may refer to, or be performed by, a person detector component as described with reference to FIG. 1. For example, a neural network or other machine learning model may be used to classify and extract position information of a face region of the person in the first 2D image. This information may then be used to crop the pixels which make up the face region,

At step 515, the system inputs the cropped image of the face of the person to a face depth map generator to create a face depth map. In some cases, the operations of this step may refer to, or be performed by, a face depth map generator as described with reference to FIG. 1. For example, the cropped image of the persons face along with the extracted position information of the face region may be used to reconstruct volumetric information of the face. This information may be converted or mapped to a 3D mesh model of a human face. An artificial neural network or other machine learning model may be used to estimate depth of pixels in the cropped image, allowing for the construction of a 3D mesh that is mapped to respective points on the cropped image. This 3D mesh is used to convert the volumetric information into a grayscale depth map of a human face.

At step 520, the system segments the first 2D photo image into person and background segments. In some cases, the operations of this step may refer to, or be performed by, a segmentation module as described with reference to FIG. 1. For example, the first 2D photo image may be analyzed by an artificial neural network or other machine learning model to classify and segment different portions of the image. The artificial neural network is trained and optimized for the detection of people and backgrounds. An edge detection process (e.g., Hough transform) may also be used to aid in the segmentation of foreground objects, like a person, from the background.

At step 525, the system assigns higher depth values to the pixels in the person segment than the pixels in the background segment to create a scene depth map. In some cases, the operations of this step may refer to, or be performed by, a segmentation module as described with reference to FIG. 1.

At step 530, the system combines the face depth map and scene depth map to create a combined depth map of the first 2D photo image. In some cases, the operations of this step may refer to, or be performed by, a combiner module as described with reference to FIG. 1. For example, the face depth map and scene depth map may be blended together and post-processed to generate the final depth map.

At step 535, the system inputs a second 2D photo image into the person detector to determine whether a person is present in the second 2D photo image. In some cases, the operation of this step may refer to, or be performed by, a person detector component as described with reference to FIG. 2. For example, the second 2D image may be analyzed by an artificial neural network or other machine learning model to determine the presence of a person or not.

At step 540, the system inputs the second 2D photo image to a scene depth map generator to create a depth map of the second 2D photo image. In some cases, the operation of this step may refer to, or be performed by, a scene depth map generator as described with reference to FIG. 2. For example, the scene depth map generator may use an artificial neural network, or other machine learning model, specifically trained and optimized for landscape and other common objects and scenes, to estimate the depths of pixels in the 2D photo image. These estimations may be used to generate a rough scene depth map that may then be post-processed to generate a final scene depth map.

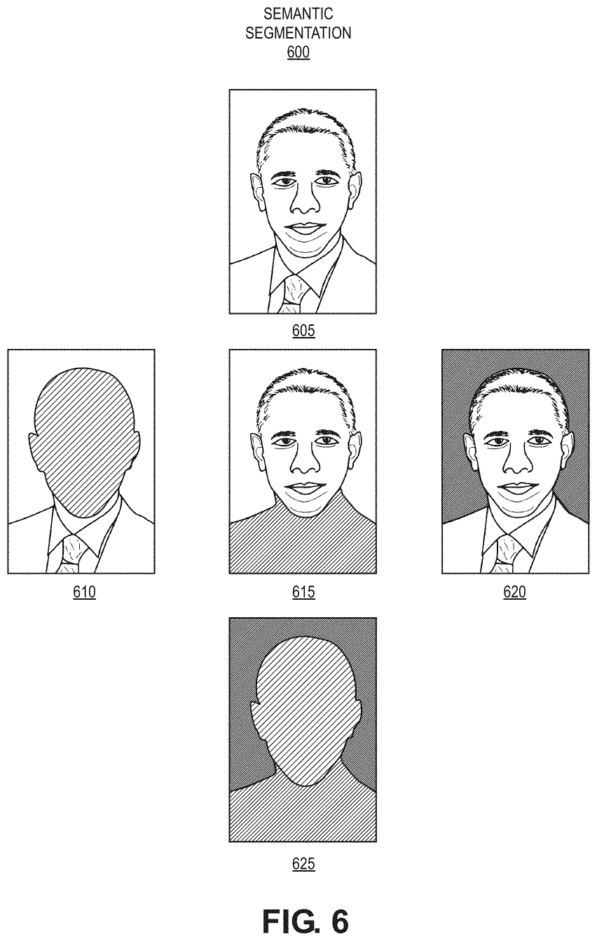

FIG. 6 shows an example of the semantic segmentation process performed by person shape semantic segmentation step 335 in accordance with aspects of the present disclosure. In this example, image 605 may be an image input by a user. Image 605 may be analyzed by one or more machine learning models, such as an artificial neural network, convolutional neural network or fully convolutional network. The one or more machine learning models may operate in parallel, or hierarchically. A hierarchical configuration of machine learning models may be implemented by serially connecting a plurality of machine learning models, such as artificial neural network, convolutional neural networks, fully convolutional networks or other neural networks.

Image 605 shows a 2D photo image that semantic segmentation is to be performed on. This image may be one of a plurality of images input by a user. Image 605 may be of a person as is shown in FIG. 6. Image 605 may alternatively be of a scene without a person, such as a landscape or scenes with non-person objects in the foreground.

In one embodiment, semantic segmentation is performed on image 605 by inputting the image into a first neural network, or machine learning model, trained to detect a person, including a human face. Images 610, 615 and 620 represent the regions classified as a face region, body region and background. The result of the classification may be represented as segmentation map 625. Segmentation map 625 may be used as input into additional neural networks or machine learning models, such as models trained to estimate depth of human faces or foreground objects. Additionally, individual segmented regions 610, 615, and 620 generated from the first neural network may also be used as inputs to additional neural networks or machine learning models.

In another embodiment, semantic segmentation is performed on image 605 by inputting the image into a first neural network, or machine learning model, trained to detect a human body and classify the pixels in the image into one of a body region 615 or a background region 620. Upon classifying the body region pixels 615 and the background region pixels 620, the first neural network may output the resulting segmentation information to a second neural network, or machine learning model, trained to detect and classify a human face. The second neural network may also use as input, image 605. The output of the first neural network, body region 615, is used as input to focus the second neural network on the region of interest (ROI). A valve-filter approach may be used to focus the attention of the neural network on a body region that has been segmented from the input image. The second neural network may then output a segmentation map 625 as a result of the focused semantic segmentation of the body region 615.

What is claimed:

1. A computer-implemented method for generating a depth map comprising:
receiving a plurality of two-dimensional (2D) photo images;
inputting a first 2D photo image into a person detector to determine whether a person is present in the first 2D photo image;
when the first 2D photo image contains a person, detecting the position of a face of the person and creating a cropped image of the face of the person;
inputting the cropped image of the face of the person to a face depth map generator to create a face depth map;
segmenting the first 2D photo image into person and background segments, each segment containing one or more pixels;
assigning higher depth values to the pixels in the person segment than the pixels in the background segment to create a scene depth map;
combining the face depth map and scene depth map to create a combined depth map of the first 2D photo image.

2. The computer-implemented method of claim 1, further comprising:
inputting a second 2D photo image into the person detector to determine whether a person is present in the second 2D photo image;
when the second 2D photo image does not contain a person, inputting the second 2D photo image to a scene depth map generator to create a depth map of the second 2D photo image.

3. The computer-implemented method of claim 1, wherein the person detector comprises a neural network trained to detect the presence of a person in an image.

4. The computer-implemented method of claim 1, wherein the face depth map generator comprises a neural network trained to generate a depth map from an image of a face.

5. The computer-implemented method of claim 4, wherein the face depth map generator is trained on a database of images comprising images that contain faces and images that do not contain faces.

6. The computer-implemented method of claim 1, wherein segmenting the first 2D photo image comprises using semantic segmentation.

7. The computer-implemented method of claim 2, wherein the scene depth map generator comprises a neural network trained to generate a depth map from an image of a scene.

8. The computer-implemented method of claim 7, wherein the scene depth map generator is optimized for generating a depth map from a landscape image.

9. The computer-implemented method of claim 1, further comprising:
generating a first 3D model from the combined depth map of the first 2D photo image;
applying one or more portions of the first 2D photo image to the first 3D model to create a first 3D image.

10. The computer-implemented method of claim 2, further comprising:
generating a second 3D model from the depth map of the second 2D photo image;
applying one or more portions of the second 2D photo image to the second 3D model to create a second 3D image.

11. A non-transitory computer-readable medium comprising instructions for:
receiving a plurality of two-dimensional (2D) photo images;
inputting a first 2D photo image into a person detector to determine whether a person is present in the first 2D photo image;
when the first 2D photo image contains a person, detecting the position of a face of the person and creating a cropped image of the face of the person;
inputting the cropped image of the face of the person to a face depth map generator to create a face depth map;
segmenting the first 2D photo image into person and background segments, each segment containing one or more pixels;
assigning higher depth values to the pixels in the person segment than the pixels in the background segment to create a scene depth map;
combining the face depth map and scene depth map to create a combined depth map of the first 2D photo image.

12. The non-transitory computer-readable medium of claim 11, further comprising instructions for:
inputting a second 2D photo image into the person detector to determine whether a person is present in the second 2D photo image;
when the second 2D photo image does not contain a person, inputting the second 2D photo image to a scene depth map generator to create a depth map of the second 2D photo image.

13. The non-transitory computer-readable medium of claim 11, wherein the person detector comprises a neural network trained to detect the presence of a person in an image.

14. The non-transitory computer-readable medium of claim 11, wherein the face depth map generator comprises a neural network trained to generate a depth map from an image of a face.

15. The non-transitory computer-readable medium of claim 11, wherein the face depth map generator is trained on a database of images comprising images that contain faces and images that do not contain faces.

16. The non-transitory computer-readable medium of claim 11, wherein segmenting the first 2D photo image comprises using semantic segmentation.

17. The non-transitory computer-readable medium of claim 12, wherein the scene depth map generator comprises a neural network trained to generate a depth map from an image of a scene.

18. The non-transitory computer-readable medium of claim 17, wherein the scene depth map generator is optimized for generating a depth map from a landscape image.

19. The non-transitory computer-readable medium of claim 11, further comprising instructions for:
generating a first 3D model from the combined depth map of the first 2D photo image;
applying one or more portions of the first 2D photo image to the first 3D model to create a first 3D image.

20. The non-transitory computer-readable medium of claim 11, further comprising instructions for:
generating a second 3D model from the depth map of the second 2D photo image;
applying one or more portions of the second 2D photo image to the second 3D model to create a second 3D image.
